(19) United States
(12) Patent Application Publication
(10) Pub. No.: US 2005/0246677 A1
(43) Pub. Date: Nov. 3, 2005

(54) Native method invocation (NMI) custom marshalling stub service

(75) Inventors: Highland Mary Mountain, Gilbert, AZ (US); Guangyu Zhu, Beijing (CN)

Correspondence Address: FLESHNER & KIM, LLP, P.O. BOX 221200, CHANTILLY, VA, 20153, US

(73) Assignee: Intel Corporation.

(21) Appl. No.: 10/835,067

(22) Filed: Apr. 30, 2004

(51) Int. Cl. G06F 9/44

(52) U.S. Cl. 717/100

(57) ABSTRACT

A method for performing code translation generates native marshaling stubs without performing ML code generation and processing. This is accomplished by calling an unmanaged function to perform a task in a managed runtime environment, accessing a pre-created native stub for the unmanaged function, and then marshaling data for the unmanaged function based on the native stub. The native stubs are created based on known parameters and return values of an associated native method signature. The stubs are then stored in a repository for retrieval when the unmanaged function is called.

### FIELD

This invention relates generally to systems and methods for controlling the execution of code in managed runtime environments.

### BACKGROUND

Recently, the number of applications controlled by Java Virtual Machine, Common Language Runtime, and other Managed Runtime Environments (MRTEs) has increased. While these applications have proven benefits, they are not without drawbacks. For example, as presently written MRTE applications do not efficiently access low-level, platform-specific, legacy-based, and other system components that lie outside the managed environment.

In many cases, maintaining system components outside the managed environment is advantageous. Doing so can result in substantial cost savings and reduce processing overhead, e.g., some platform-specific features cannot be comprehended by MRTEs and thus locating these features outside the managed setting can lead to reduced system complexity.

Existing techniques for controlling access of unmanaged components by MRTEs are inefficient. This is especially true of Common Language Infrastructure (CLI) applications. Created as the foundation of .Net technology, CLI is an ECMA standard which allows applications to be written in a variety of high-level programming languages and executed in different system-specific environments. Programming languages which conform to CLI have access to the same base class library and can be compiled into the same intermediate language (IL) and metadata. The IL is then further compiled into native code for a specific architecture. Because of this intermediate compiling operation, applications do not have to be rewritten from scratch (i.e., the IL only needs to be further compiled into a system's native code), thereby improving processing speed and efficiency.

Rotor is a publicly available implementation of the Common Language Runtime (CLR) application. Rotor generates code for marshaling data between managed and unmanaged components during program execution time. This code is either interpreted or compiled to native code and executed. The generation and interpretation of marshaling code adds significant overhead to the overall application processing and thus has proven undesirable. A need therefore exists for a system and method to efficiently control access of unmanaged components and managed runtime environments.

### BRIEF DESCRIPTION OF THE DRAWINGS

FIG. 1 is a table showing an example of the processing overhead created when native method argument types are passed between managed and native data representations.

FIG. 2 is a flow chart showing functional blocks performed by a marshaling language process in an MRTE according to one embodiment of the present invention.

FIG. 3 is a diagram showing functional blocks performed by a custom marshaling stub service according to the aforementioned embodiment of the present invention.

FIG. 4 is diagram showing a process where a native stub helper function locates a native DLL entry point of a native method called in accordance with the aforementioned embodiment of the present invention.

FIG. 5 shows pre-processing blocks that may be performed before runtime ML processing, for example, in accordance with FIG. 2.

FIG. 6 is a diagram showing a processing system which may include a custom marshaling stub service manager in accordance with one or more embodiments of the present invention.

### DETAILED DESCRIPTION OF PREFERRED EMBODIMENTS

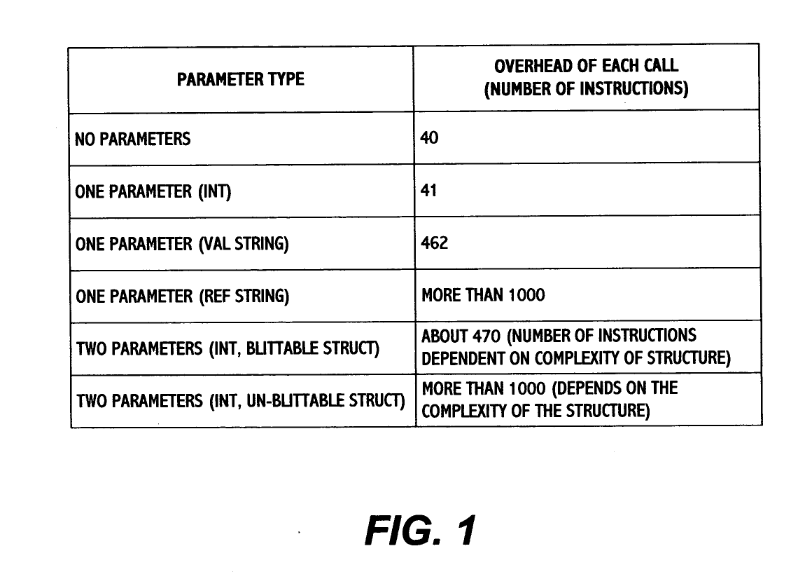

The process of generating a marshaling language script and then generating native stubs according to a native method signature increases complexity of a managed runtime environment and therefore may be considered undesirable from a developer's standpoint. This complexity is evident from FIG. 1, which provides an indication of the processing overhead (measured in numbers of instructions per call) required to implement a process of this type. More specifically, FIG. 1 shows overhead which can be created when various native method argument types are passed between managed and native data representations.

In considering this overhead, simple data types such as integers and floating-point numbers have a common representation in both managed and unmanaged memory and thus do not require marshaling. This type of data is known as blittable (or isomorphic) data because they do not require conversion when passed between managed and unmanaged code. Arrays of blittable types and classes containing only blittable members are considered complex blittable types. These blittable data types may be pinned instead of copied during marshaling, e.g., they can appear to be marshaled as in/out parameters when the caller and callee are in the same apartment. (In contrast, non-blittable data types have different or ambiguous representations and therefore might require conversion when marshaled between managed and unmanaged code).

In accordance with one embodiment of the present invention, the overhead associated with FIG. 1 may be substantially reduced by predicting the resulting native stub for a native method signature. (A stub is a piece of dynamically created code that performs various tasks during program execution). Native method signatures are generally known and may be understood in accordance with the following non-limiting example.

The CLI standard allows for interoperation between C# code, for example, and native code written in another language, e.g., CLI allows C# code to execute applications in other languages and thus allows Common Language Runtime (CLR) to be hand-off executed to a native method. To make this possible, a native method is included with a static extern declared within a C# class. (The native keyword signals to the C# compiler that the method is a native language method). The static extern declaration in the C# class provides for the native method signature, along with a DllImport command which declares the path to the native Dll.

A native method signature with known parameters and return values may be used to create native stubs (custom marshaling stubs) for marshaling parameter data to and from a native code representation. The dynamic nature of ML processing and interpretation may be maintained, however ML code generation and the ML interpretation process may be avoided for native methods offering pre-created marshaling stubs as described herein. ML refers to a special-purpose intermediate language used for implementing parameter translation between managed and unmanaged code. This language is called upon, for example, to call one or more native methods, arguments, and return values to be marshaled from an MRTE data representation to an equivalent native environment representation. (Native code refers to code which has been compiled for a specific hardware platform).

In accordance with the present embodiment, a process is provided which allows native methods to provide marshaling stubs that can be detected by an MRTE before the MRTE generates its own version of the stub. In implementing this process, a customized native marshaling stub is pre-created, stored, and then used in a format which can be comprehended by the MRTE, e.g., a Rotor application. While a Rotor application is advantageous, it is emphasized that the embodiments of the present invention may be applied to other ML applications and/or managed runtime environments.

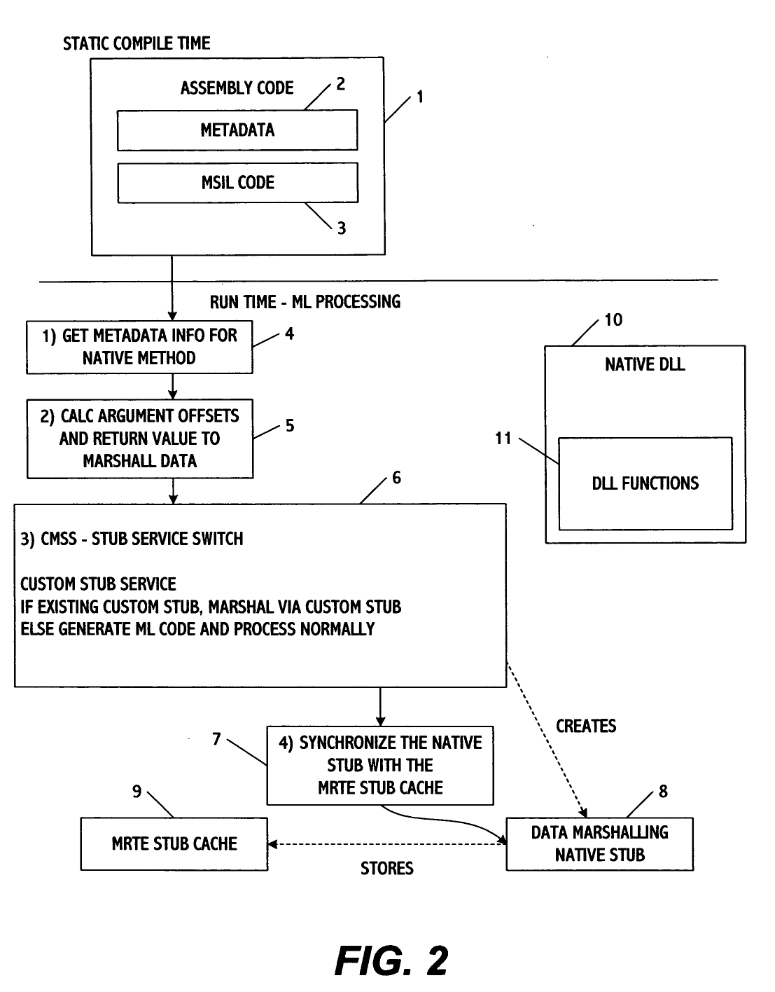

FIG. 2 is a flow chart showing functional blocks included in a process for developing code in a managed runtime environment in accordance with the present embodiment. In this embodiment, a native method signature with known parameters and return values are used to create and pre-store custom native stubs for marshaling parameter data for a predetermined unmanaged function. This custom stub is then used for marshaling when a managed object (e.g., Rotor application) calls the unmanaged function to perform various tasks, e.g., p/invoke call, stack management, etc. The marshaling may involve, for example, translating arguments from CLI common data types into the platform's native data types.

Formation of a custom marshaling stub from a native method signature with known parameters and return values is performed based on a number of factors, which include, for example, the version of ML code currently being used, the manner in which the code and its end result is parsed, and other recognized standards. The stub is preferably formed based on both the signature and return values, as the information may be placed on the stack to represent how the parameters will be represented in the native code as well as what return values are expected back when execution returns to the MRTE.

Custom marshaling stubs may also be formed based on information about the native platform (e.g., hardware platform) the native method will be executed on. For example, the ML process may need to know that the native code will be executed on a x86 machine. The native platform corresponds to the hardware platform The present embodiment may be implemented, for example, on any native platform which is supported by CLR.

One approach that can be taken to form a custom marshaling stub involves using a performance monitoring tool (e.g., Intel's VTune) to interrogate an ASM being placed on the stack during ML code processing. In implementing this tool the ML code may be the same for a given method signature, which will result in the same marshaling stub being produced. Given the predictability of the resulting stub, a similar process may be used to provide a method signature's marshaling stub.

During stub formation, each parameter of a given native method signature may be used to determine what data can potentially be marshaled. The same is true for a return value, if there is one. For example, when a legacy application such as SAP publishes an API, known parameters and return values are described which may be used to form the custom marshaling stub.

Not all native methods have return values. In this case, the values are declared as void method calls. An example of how a return value may be generated is given as follows:

DllImport(“NativeLib.dll”)
public static extern int TestUnion(MyUnion u, int type)

The above implies that an integer value will be returned after the native call is made. This return value could be tested in an “if” statement or assigned to a variable in the MRTE application such as follows:

int testReturn = TestUnion(MyUnion u, int type);
if testReturn then
//ok
else
//print error. . . . .
endif;

In performing the process of FIG. 2, the dynamic nature of ML Rotor processing and interpretation may remain. However, for native methods based on pre-created marshaling stubs, ML code generation and the ML interpretation process may be avoided. In other words, marshaling stubs may be pre-created using prior knowledge of the native application's interface signature and then selected to thereby reduce overhead and improve processing efficiency. This process is explained in greater detail below.

During static compile time, assembly code 1 to be marshaled is compiled. This code includes metadata 2 and Microsoft Intermediate Language (MSIL) code 3. The metadata and MSIL code may be obtained through a static compile process of the CLI language being used. One example is a C# static compiler, which reads the C# code and determines the Metadata and MSIL.

During run time of ML processing, the metadata from the statically compiled assembly code is referenced to determine the particular signature for a given native method declared. (Block 4). Argument offset values are then calculated. These values may include native method parameter types, return value types, and/or corresponding method or field attributes. (Block 5). These values are then returned for the purpose of marshaling data using a custom marshaling stub service. (Block 5).

Instead of generating an ML script for the native method call (e.g., a specific natively compiled method called by an MRTE application), the Custom Marshaling Stub Service (CMSS) performs a check to determine whether a custom marshaling stub has been pre-created for the native method. For example, the custom marshaling stub service may check a repository (e.g., a filing system or database) that stores a pre-created marshaling stub corresponding to the native method. The repository may be indexed and thus searched by the CMSS based on the signature of the native method alone or along with other unique method attributes. The CMSS may be formed, for example, from a simple index lookup thru a table or directory structure, however alternative arrangements may be used.

If a matching custom marshaling stub is found in the repository, the stub may be placed on the stack to facilitate data marshalling both to and from the native method. On the other hand, if the CMSS does not find a matching custom stub the CLR will run a pre-stub and jump into the codes to create the native stub. (Block 6). In other words, the CMSS will generate a marshaling language script and then a native stub based on the native method signature. (The stack stores executable assembly code prior to execution. When it is time to execute the assembly code, associated commands are executed by the MRTE. Thus, in Block 6, the custom marshaling stub may be placed on the stack for execution by the MRTE.)

If a custom marshaling stub is found in the repository, the stub is synchronized with a stub cache of the MRTE. (Block 7). The synchronization may be performed, for example, using an existing function of the MRTE. Otherwise, the CMSS places the stub into memory for storage. Whether located in the repository or created, the parameters in the native method signature are marshaled. (Block 8). After marshaling is completed, the resulting converted code may be stored in an MRTE stub cache. (Block 9).

The native dynamic link library (DLL) 10 corresponds to the native code to be called from the MRTE, and includes one or more DLL functions 11 one of which is being called by the MRTE. In FIG. 2, the native Dll therefore contains the native method called by the MRTE application.

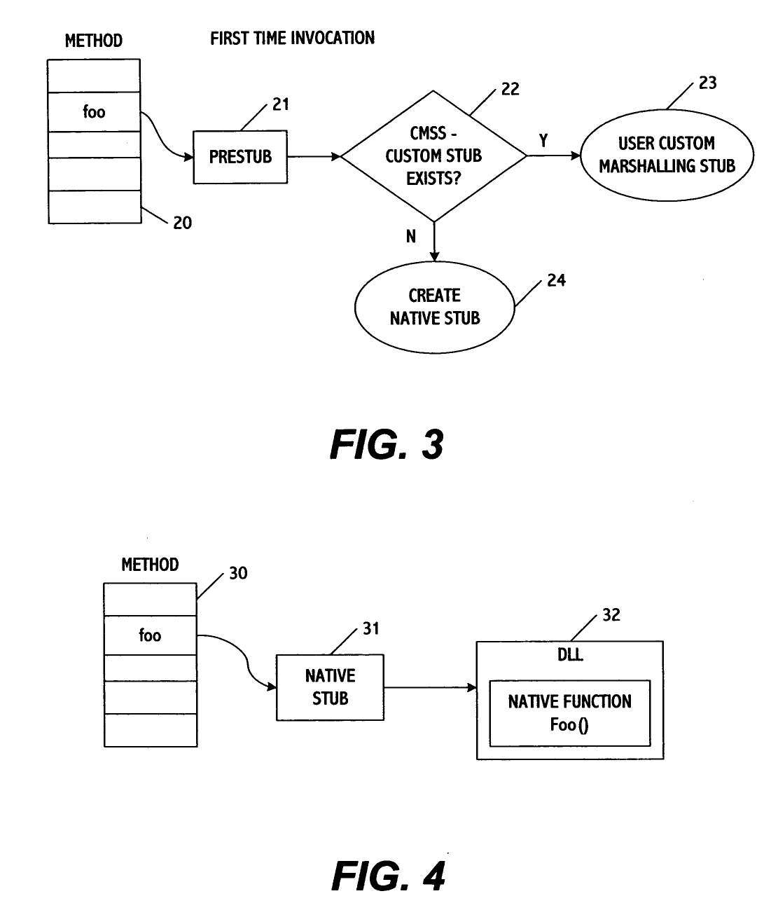

FIG. 3 is a flow chart showing blocks performed by the CMSS of a Rotor application for an exemplary unmanaged native function foo ( ). Prior to runtime execution, a custom marshaling stub may be formed and stored in the repository for this function. During runtime, this function may be allocated as an entry in a method table 20. This method table lists at least one and preferably all the methods (along with associated data) being used by a given MRTE application at runtime—managed or unmanaged. Native methods or methods declared as static externs have native stubs referenced by this table.

When native function foo( ) is called, for example, from within a C# method such as caller( ), a Common Language Runtime (CLR) manager within the CMSS may perform a look-up operation in the method table which was formed for a predetermined class, e.g., the class App. If native function foo( ) is being called for the first time, a pre-stub may exist in the table entry for this function, as shown in Block 21. The pre-tub may be a small fragment of code that can be evaluated by the CMSS manager at runtime to bind the method table to reference to an entry point. All pre- and post-processing of method calls needed by the execution engine is preferably set up in the pre-stub.

The CMSS then determines whether a custom marshaling stub has been pre-formed for the foo( ) function. (Block 22). This determination involves searching the repository for the custom marshaling stub formed for the foo( ) function. If a matching custom stub is found, it is used to marshal (transform) code associated with the foo( ) function into native code stubs. (Block 23).

If a custom marshaling stub is not found, the CMSS hands over operations to the CLR as normal. (Block 24). That is, first, native method parameter types, return value types and the corresponding method or field attributes are used to determine the generation of ML codes for foo( ). Then, an appropriate DLL entry point and native library are loaded. During a compiling and/or interpreting operation, the ML code stubs transform into corresponding native code stubs.

Once a native code stub is obtained either as a result of Blocks 23 or 24, the stub may be stored in an associated MRTE cache and used to marshal code between the MRTE and an unmanaged application.

FIG. 4 shows that once the native stub 31 is determined for a given method call, it is referenced by the method table 30 for successive calls to that native function, in association with DLL 32.

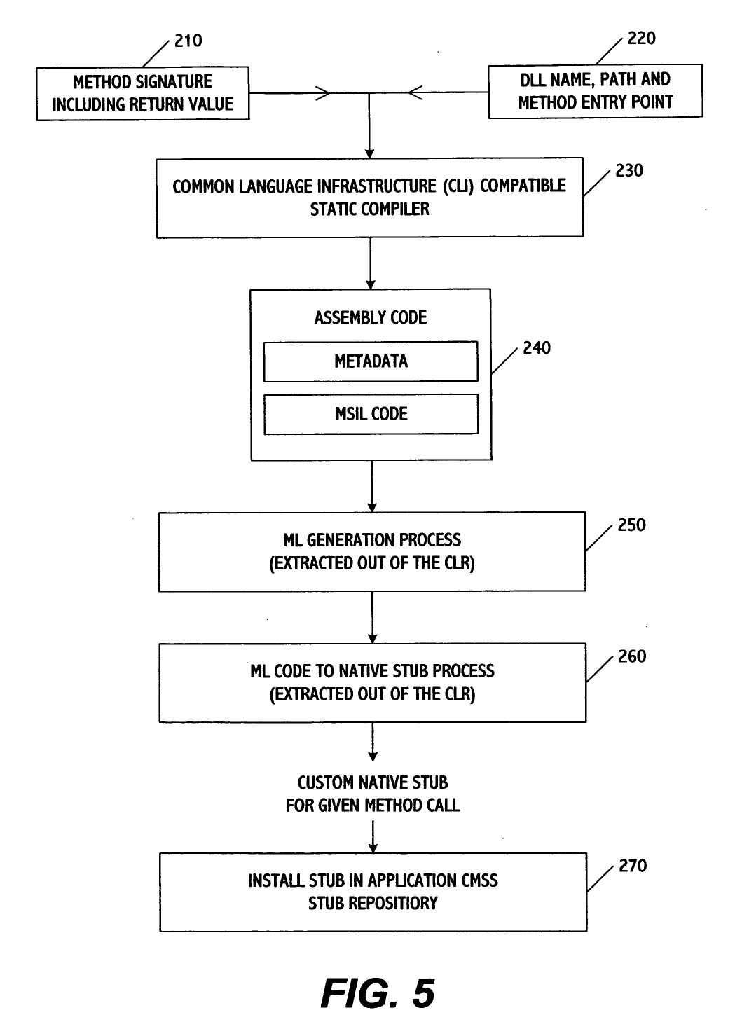

FIG. 5 shows pre-processing blocks that may be performed before runtime ML processing, for example, in accordance with FIG. 2. Here, the process of forming a custom marshaling stub is initially based on designation of a static method extern declaration for a native method signature that includes one or more return values. Block 210. This is accompanied by a DLL input statement indicating information such as DLL name, path, and method entry point. Block 220. This information is then input into a Common Language Infrastructure compatible with a static compiler. Block 230.

Remaining operations correspond to those previously discussed in FIG. 2. For example, assembly code including metadata and MSIL code output from the compiler (Block 240) is used as the basis for ML generation process (Block 250), and the result is used to form ML code for generating a corresponding custom native stub for a given method call (Block 260). The custom stub is then installed in an application CMSS stub repository for later retrieval. Block 270.

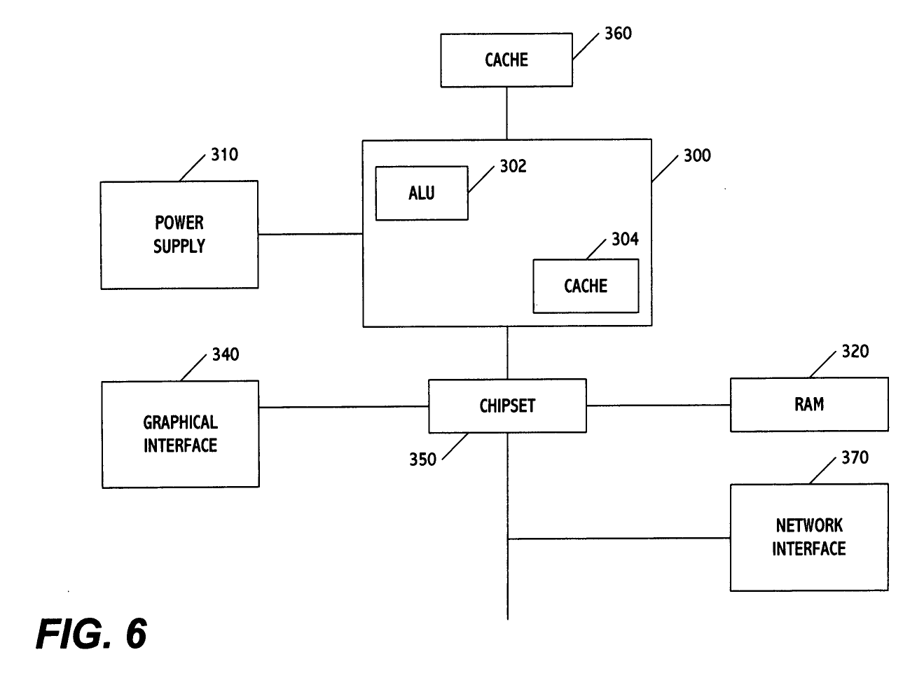

FIG. 6 shows a processing system which includes a processor 300, a power supply 310, and a memory 320 which, for example, may be a random-access memory. The processor includes an arithmetic logic unit 302 and an internal cache 304. The system also preferably includes a graphical interface 340, a chipset 350, a cache 360, and a network interface 370. The processor may be a microprocessor or any other type of processor. If the processor is a microprocessor, it may be included on a chip die with all or any combination of the remaining features, or one or more of the remaining features may be electrically coupled to the microprocessor die through known connections and interfaces.

The embodiments of the present invention described herein may be implemented in the system of FIG. 6. For example, the repository for storing one or more custom marshaling stubs may be included in the cache or memory for quick access. The compiler and manager for creating the marshaling stubs may be located off- or on-chip (e.g., in the chipset).

The embodiments of the present invention described herein thus provide a framework for native methods to pre-create and store custom marshaling stubs for MRTE application sessions, before the MRTE generates its own version of the stub. By automatically forming and then pre-storing custom marshaling stubs in this manner, native library providers can reduce the p/Invoke overhead due to data marshalling. Also, native library integration with CLR can be more effectively streamlined, thereby reducing the number of IA instructions by a factor of 5:1 or more depending on the complexity of the method parameters. Parameters which may benefit the most from this optimization technique include string by reference, string by value, and non-blittable structures as well as others. Marshalling blittable structures would also be optimized if a first optimization was not initially performed.

In another embodiment, the design of the CMSS may be extended to dynamically download pre-created native library custom marshaling stubs from a reliable source. MRTEs equipped in this manner could then be configured to check third-party-supplied URL's for such stubs. A periodic update process could also be designed into this download process. For all embodiments herein, an attribute could be designed to allow for the downloading or repository search features to be turned off on a per-application or per-native method declaration. Also, by predicting the marshalling language interpretation process result, the interpretation process normally performed can be circumvented by one or more embodiments of the present invention, thereby substantially reducing overhead.

Another embodiment of the present invention is a computer-readable medium which stores code for implementing all or a portion of the functional blocks of the methods described above. This medium may be in any form capable for storing code including magnetic and optical. Examples include an integrated circuit chip storing the code, a compact disk, floppy disk, flash memory, EEPROM, or any other code-bearing medium.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the embodiments of the invention. In addition to variations and modifications in the component parts and/or arrangements, alternative uses will also be apparent.

1. A method, comprising:
calling an unmanaged function to perform a task in an MRTE;
accessing a pre-created native stub for the unmanaged function; and
marshaling data for the unmanaged function based on the native stub.

2. The method of claim 1, further comprising:
storing the pre-created native stub in a repository before the unmanaged function is called by the MRTE.

3. The method of claim 2, wherein accessing the native stub includes:
identifying an attribute of a native method corresponding to the native stub; and
searching the repository for the native stub based on the attribute.

4. The method of claim 1, wherein marshaling data includes:
marshaling parameter data between MRTE and native code representations using the native stub.

5. The method of claim 1, wherein marshaling data includes:
translating at least one argument from a CLI common data type into a native data type of a predetermined platform.

6. The method of claim 1, wherein marshaling data for the unmanaged function based on the pre-created native stub is performed without ML code generation and interpretation.

7. The method of claim 1, further comprising:
creating the native stub from a native method signature having one or more known parameters and return values.

8. The method of claim 1, further comprising:
creating the native stub in a format compatible with the MRTE.

9. The method of claim 8, wherein the MRTE includes a Rotor application.

10. A method, comprising:
obtaining metadata from compiled assembly code;
determining a native method signature based on the metadata;
accessing a pre-stored native marshaling stub for the native method signature; and
marshaling data between native code and MRTE representations using the native stub.

11. The method of claim 10, further comprising:
calculating one or more argument offset values for the native method; and
marshaling the parameter data based on the offset values.

12. The method of claim 11, wherein the offset values include one or more of a native method parameter type, a return value type, and a method for field attribute.

13. The method of claim 10, wherein the native stub is stored in a repository before an unmanaged function is called by the MRTE.

14. The method of claim 13, wherein accessing the native stub includes:
identifying an attribute of the native method; and
searching the repository for the native stub based on the attribute.

15. The method of claim 10, wherein marshaling the parameter data using the native stub is performed without ML code generation and interpretation.

16. The method of claim 10, further comprising:
creating the native stub from one or more known parameters and return values of the native method signature.

17. A system, comprising:
a repository to store a native stub for an unmanaged function;
a manager to retrieve the native stub from the repository when the unmanaged function is called by an MRTE; and
a translator to marshal data for the unmanaged function between native code and MRTE representations using the native stub.

18. The system of claim 17, wherein the repository stores the native stub based on at least one attribute of a native method corresponding to the native stub.

19. The system of claim 18, wherein said at least one attribute is at least one of a native method parameter type, a return value type, and a method or field attribute.

20. The system of claim 17, wherein the translator marshals data for the unmanaged function using the native stub without ML code generation and interpretation.

21. The system of claim 17, further comprising:
a code generator to generate the native stub from a native method signature having one or more known parameters and return values.

22. A computer-readable medium storing a program comprising:
a first code section to call an unmanaged function to perform a task in an MRTE;
a second code section to access a pre-created native stub for the function; and
a third code section to marshal data for the function based on the native stub.

23. The computer-readable medium of claim 22, wherein the second code section causes a manager to retrieve the pre-created native stub from a repository when the function is called by the MRTE.

24. The computer-readable medium of claim 23, wherein the second code section causes the manager to retrieve the pre-created stub by:
identifying an attribute of a native method corresponding to the native stub; and
searching the repository for the native stub based on the attribute.

25. The computer-readable medium of claim 22, wherein the third code section causes a translator to marshal parameter data between MRTE and native code representations using the native stub.

26. The computer-readable medium of claim 22, wherein the third code section causes the translator to marshal said parameter data without ML code generation and interpretation.

27. The computer-readable medium of claim 22, further comprising:
a fourth code section to create the native stub from a native method signature having one or more known parameters and return values.

28. A system comprising:
at least one signal line; and
a memory to store information including a pre-created native stub for an unmanaged function received through the signal line.

29. The system of claim 28, wherein the memory is one of a cache and a random access memory.

30. The system of claim 28, wherein the signal line and memory are formed on a single integrated circuit die.
